(19) United States
(12) Patent Application Publication
(10) Pub. No.: US 2010/0070265 A1
(43) Pub. Date: Mar. 18, 2010

(54) APPARATUS, SYSTEM, AND METHOD FOR MULTILINGUAL REGULATION MANAGEMENT

(76) Inventors: David D. Nelson, Park City, UT (US); Richard B. Nordgren, Sandy, UT (US)

Correspondence Address: Kunzler & McKenzie, 8 EAST BROADWAY, SUITE 600, SALT LAKE CITY, UT, 84111, US

(21) Appl. No.: 12/622,231

(22) Filed: Nov. 19, 2009

Related U.S. Application Data
(63) Continuation-in-part of application No. 10/855,935, filed on May 27, 2004.
(60) Provisional application No. 60/473,679, filed on May 28, 2003.

(51) Int. Cl. G06F 17/20

(52) U.S. Cl. 704/8

(57) ABSTRACT

An apparatus, system, and method are disclosed for automatically displaying regulations in a first language from a search in a second language under the invention, a regulation storage module is configured to store a regulation of a country and associated information in a first language in a database. A regulation search module is configured to search in a second language information in the database regarding a regulation in the first language. A display module is configured to display the regulation identified by the regulation search module.

### CROSS-REFERENCES TO RELATED APPLICATIONS

This application is a continuation of U.S. patent application Ser. No. 10/855,935 entitled “Method, Apparatus and System for Regulation Translation” which was filed on May 27, 2004 and incorporated herein by reference. Application Ser. No. 10/855,935, in turn, claims priority benefit of U.S. Provisional Patent Application No. 60/473,679 entitled “Method, Apparatus and System for Regulation Translation” which was filed on May 28, 2003, incorporated herein by reference.

### BACKGROUND

1. Field

This invention relates to automated systems for providing access to governmental regulations and more particularly relates to automated systems for identifying, accessing, displaying, tracking changes, and updating culturally, technically appropriate and linguistically accurate interpretations and translations of regulations.

2. Description of the Related Art

For businesses, institutions, and agencies that work and operate internationally, one of the major hurdles is identifying the relevant governmental authority(s) as well as selecting, locating, obtaining, analyzing, and interpreting a particular country's governmental regulations. For example, a company planning for and/or setting up or divesting of a manufacturing plant in a foreign country needs to know the applicable regulations such as air pollution standards or waste water emissions requirements. Identifying, locating, and obtaining an official government copy in the wide variety of media and formats of the applicable regulations is a very significant hurdle. Complicating this matter is the fact that local jurisdictional regulations as well as national regulations may be involved. Additionally, there may be proposed and/or pending regulations that have not reached final government approval, codification, and promulgation that are of concern to the company. Dealing with such matters typically requires a significant amount of uncertainty, time and expenses as well as international travel by company representatives to foreign countries. The company is not only required to identify and obtain the regulation, but to also identify the proper governmental authorities that are in charge of the implementation and enforcement of the regulation.

Additionally, the company will likely also have to analyze, interpret, and possibly fully translate the regulations. This is complicated by the fact that a straight translation (i.e., word-for-word or phrase-by-phrase) of a regulation may not account for the significance and technical nuance of the regulation in the particular linguistic alternative options and culture. A particular phrase may have one meaning in the company's home country and its governmental regulations that is completely different from that in the foreign country in which a new manufacturing plant is located. Again, the company, institution, or agency seeking the information will need to find an expert that not only can translate the regulation, but also has specific technical and linguistic knowledge and experience of how the regulation is interpreted in the particular official language and culture.

At the present time, there is no single repository of world-wide governmental regulations that allows a user to find a regulation of a foreign country and subsequently provides a linguistically and culturally accurate translation of the regulation. While the Internet allows access to a wide variety of information, identifying and contacting the proper governmental authority(s) implementing and enforcing a particular regulation and then obtaining a linguistically and culturally accurate translation and interpretation of the regulation is not readily available. Similarly, Internet provision of governmental regulations from official sources are typically not complete, accurate, nor reflect changes and amendments already in place and enforceable by relevant governmental agencies.

From the foregoing discussion, it should be apparent that a need exists for an apparatus, system, and method that allows a user to access, track, update, and analyze governmental regulations throughout the world and numerous jurisdictions that are accompanied by linguistically and culturally accurate translations in and from official government language(s). Beneficially, such an apparatus, system, and method would allow a user to access a regulation from a particular country through the Internet or some other computer network, display the particular governmental regulation, display a linguistically and culturally accurate summary of the regulation and translation, and highlight key regulatory phrases along with linguistically and culturally accurate translations of the words and phrases.

### SUMMARY

The present invention has been developed in response to the current state of the art, and in particular, in response to the problems and needs in the art that have not yet been fully solved by currently available systems for accessing world-wide governments regulations and related information. Accordingly, the present invention has been developed to provide an apparatus, system, and method for identifying, obtaining, analyzing, tracking, searching and displaying regulations and associated pertinent regulatory information and documents from various countries where the regulations are in a first and/or governmental (i.e., official) language(s) and searching and displaying it in a second language that overcomes many or all of the above-discussed shortcomings in the art.

The apparatus to display regulatory documents is provided with a logic unit containing a plurality of modules configured to functionally execute the necessary steps of displaying information regarding regulations in a first language from a search in a second language. These modules in the described embodiments include a regulation storage module for storing information regarding a regulation of a country that is officially recorded in a first language in a database, a regulation search module for searching in a second language the information regarding the regulation in the first language, and a display module for displaying the information regarding the regulation identified by the regulation search module. In an alternate embodiment, the information regarding the regulation is a regulation officially recorded in a first language of the regulation's country of origin.

The regulation search module, in one embodiment, is further configured to translate search terms in a second language to a first language and search a regulation in the first language. The display module, in another embodiment, displays information linked to the regulation identified by the search module.

The apparatus is further configured, in one embodiment, to include a regulation summary display module for displaying a summary of the regulation identified by the regulation search module. The regulation summary display module further includes a regulation summary storage module which stores a summary of a regulation in a first language of the country of the regulation's origin and in a second language, a summary selection module which allows a user to select a summary of the regulation identified by the regulation search module from the regulation summary storage module in the first language of the country of the regulation's origin or the second language, and a summary display module that displays the selected summary on the display module.

In one embodiment, the regulation summary is written and translated by a person with actual knowledge of the regulation being summarized, its application in the country and culture of the regulation's origin, and knowledge of how to translate the regulation from the first language of the country of origin to the second language such that technical nuances and translation alternatives are appropriately embodied in the second language. In another embodiment, the regulation summary may also include information such as a business impact, a compliance requirement list, an agency contact list, a regulatory agency name, agency organizational charts or similar information.

In a further embodiment, the apparatus may be configured to include a terminology guide filtering module for highlighting key regulatory terms in a regulatory document. The terminology guide filtering module further includes a terminology guide storage module which stores a key regulatory term and linked associated information, a key regulatory term search module which searches a regulatory document for a key regulatory term when the regulatory document is to be displayed on the display module, a terminology guide highlight module which highlights the key regulatory term found in the regulatory document displayed on the display module, and a terminology guide display module which displays the associated information linked to a key regulatory term found in the regulatory document on the display module as a mouse cursor passes over the highlighted key regulatory term.

In another embodiment, the apparatus may be configured to include a regulatory document counting module for counting the number of times each of a group of regulatory documents is accessed. The regulatory document counting module further includes a document grouping module to separate regulatory documents into groups, a counting module to count the number of times a regulatory document within a group is accessed, a prioritization module to assign a priority level to each regulatory document within a group based on the count from the counting module, and a determination module to determine an action to be taken on a regulatory document based on the priority level assigned by the prioritization module.

In one embodiment, the action to be taken on a regulatory document by the determination module is to translate the regulatory document. In another embodiment, the action to be taken on a regulatory document by the determination module is to extract key regulatory terms. In yet another embodiment, the action to be taken on a regulatory document by the determination module is to assess business impacts.

In a further embodiment, the apparatus may be configured to include a compare module which compares a regulation to one or more corresponding regulations from a different jurisdiction or country. In an alternate embodiment, the compare module compares tabulated data extracted from a regulation to tabulated data extracted from one or more corresponding regulations from a different jurisdiction or country. The compare module may also compare the regulations to corresponding user data.

The apparatus may also include a forms module configured to allow users to select, use, and print official government forms. The apparatus may also include a regulatory information storage module that contains information from a country such as a permitting requirement, a compliance schedule, a country regulation overview, an emissions table, or the like.

A system of the present invention is also presented to display regulatory documents. The system may be embodied by a computer network, a computer connected to the computer network, a server connected to the computer network, and a regulatory document display apparatus connected to the computer network. The regulatory document display apparatus includes a regulation storage module which stores information regarding a regulation of a country that is officially recorded in a first language in a database, a regulation search module which searches in a second language the information regarding the regulation in the first language, and a display module which displays the information regarding the regulation identified by the regulation search module. In an alternate embodiment, the information regarding the regulation is a regulation officially recorded in a first language of the regulation's country of origin. In a further embodiment, the system includes an Internet connection wherein a user can access the database through the Internet.

In particular, the system, in one embodiment, includes a regulation summary display module that displays a summary of the regulation identified by the regulation search module. The regulation summary display module further includes a regulation summary storage module which stores a summary of a regulation in a first language of the country of the regulation's origin and in a second language, a summary selection module which allows a user to select a summary of the regulation identified by the regulation search module from the regulation summary storage module in the first language of the country of the regulation's origin or the second language, and a summary display module which displays the selected summary on the display module.

The system may further include a terminology guide filtering module for highlighting key regulatory terms in a regulatory document. The terminology guide filtering module includes a terminology guide storage module that stores a key regulatory term and linked associated information, a key regulatory term search module that searches a regulatory document for a key regulatory term when the regulatory document is to be displayed on the display module, a terminology guide highlight module that highlights the key regulatory term found in the regulatory document displayed on the display module, and a terminology guide display module that displays the associated information linked to a key regulatory term found in the regulatory document on the display module as a mouse cursor passes over the highlighted key regulatory term.

The system may further include a regulatory document counting module for counting the number of times each of a group of regulatory documents is accessed. The regulatory document counting module includes a document grouping module which separate regulatory documents into groups, a counting module which counts the number of times a regulatory document within a group is accessed, a prioritization module which assigns a priority level to each regulatory document within a group based on the count from the counting module, and a determination module which determines an action to be taken on a regulatory document based on the priority level assigned by the prioritization module.

In addition, the system may include a compare module which compares a regulation to one or more corresponding regulations from a different jurisdiction or country. Alternatively, the system includes a forms module which allows users to select, use, and print official government forms.

A method of the present invention is also presented for searching and displaying regulations and associated pertinent regulatory information and documents from various countries where the regulations are in a first language and searching and displaying is in a second language. The method in the disclosed embodiments substantially includes the steps necessary to carry out the functions presented above with respect to the operation of the described apparatus and system. In one embodiment, the method includes displaying information regarding regulations in a first language from a search in a second language. The method also may include storing information regarding a regulation of a country that is officially recorded in a first language in a database, searching in a second language the information regarding the regulation in the first language, displaying the information regarding the regulation identified by the regulation search. In an alternate embodiment, the information regarding the regulation is a regulation officially recorded in a first language of the regulation's country of origin. In another embodiment, searching in a second language comprises translating search terms in a second language to a first language and searching a regulation in the first language

In a further embodiment, the method includes displaying a summary of the regulation of a country identified by the regulation search, which further includes storing a summary of a regulation in a first language of the country of the regulation's origin and in a second language, selecting a summary of the regulation identified by the regulation search in the first language of the country of the regulation's origin or the second language, and displaying the selected summary. In another embodiment, the method includes highlighting key regulatory terms in a regulatory document, which further includes storing a key regulatory term and linked associated information, searching a regulatory document for a key regulatory term when the regulatory document is to be displayed, highlighting the key regulatory term found in the displayed regulatory document, and displaying the associated information linked to a key regulatory term found in the displayed regulatory document as a mouse cursor passes over the highlighted key regulatory term.

The method, in another embodiment, includes counting the number of times each of a group of regulatory document is accessed which also includes separating regulatory documents into groups, counting the number of times a regulatory document within a group is accessed, assigning a priority level to each regulatory document within a group based on the number of times a regulatory document within a group is counted, and determining an action to be taken on a regulatory document based on the assigned priority level of the regulatory document. In another embodiment, the method further comprises comparing a regulation to one or more corresponding regulations from a different jurisdiction or country. In yet another embodiment, the method includes allowing users to select, use, and print official government forms.

A method of the present invention is also presented for managing regulatory documents in a database which includes developing a database of regulations from various countries that is searchable by country, developing a global resource network comprising persons to develop and maintain information in the database with actual knowledge of regulations of a country or jurisdiction, their application in the country and culture of the regulations, and knowledge of how to translate a regulation from a first language of the country of the regulation's origin to a second language, providing Internet and network access to users of the database, and providing a login procedure to limit access to the database to authorized users.

The database may further include regulations, translations of the regulations, current, proposed, or archived versions of the regulations, summaries of the regulations in a first language of the country of the regulation's origin and a second language, a business impact of a regulation, permitting requirements of various jurisdictions, compliance schedules, effluent and emissions standards, site assessment and contamination standards, contact information for regulatory agencies, reporting and auditing requirements, health and safety standards, country overviews, active litigation monitoring information, public accessible information, translated chemical names, news, a list of requirements of how to comply with regulations, a terminology guide comprising key regulatory terms, and the like. In addition, the method may include allowing members of the global resource network access through the Internet to the database to add new regulations, construct new regulatory documents, add key regulatory terms, update previously added information, or harmonize added and updated information with other members of the global resource network.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for displaying regulatory documents in accordance with the present invention;

FIG. 2 is a more detailed schematic block diagram illustrating one embodiment of an apparatus for displaying regulatory documents in accordance with the present invention;

FIG. 3 is a schematic block diagram illustrating one embodiment of a regulation summary display module in accordance with the present invention;

FIG. 4 is a schematic block diagram illustrating one embodiment of a terminology guide filtering module in accordance with the present invention;

FIG. 5 is a schematic block diagram illustrating one embodiment of a regulatory document counting module in accordance with the present invention;

FIG. 6a is a schematic flow chart diagram illustrating one embodiment of a method for displaying a regulation in a first language that was identified from a search in a second language in accordance with the present invention;

FIG. 6b is a depiction of an example of various search parameters to search for regulations in accordance with the present invention;

FIG. 7a is a schematic flow chart diagram illustrating one embodiment of a method for displaying a selected summary of a regulation in a first language of the country of the regulation or in a second language in accordance with the present invention;

FIG. 7b is a front view of a display of a summary of a regulation in a first language of the country of the regulation in accordance with the present invention;

FIG. 7c is a front view of a display of a summary of a regulation in a second language in accordance with the present invention;

FIG. 8a is a schematic flow chart diagram illustrating one embodiment of a method for highlighting key terms in a displayed document in accordance with the present invention;

FIG. 8b is a front view of a display of a displayed document with a key regulatory term highlighted in accordance with the present invention;

FIG. 8c is a front view of a display of a displayed document with a key regulatory term highlighted, a mouse cursor over the highlighted term, and associated information for the key regulatory term displayed in accordance with the present invention;

FIG. 9 is a schematic flow chart diagram illustrating one embodiment of a method for counting when a regulatory document is accessed, assigning a priority ranking to a regulatory document within a group, and processing the regulatory document based on the priority in accordance with the present invention;

FIG. 10a is a schematic flow chart diagram illustrating one embodiment of a method for comparing regulations in accordance with the present invention; and

FIG. 10b is a front view of a display of tabulated data from a regulation from a country and selection of another regulation to compare in accordance with the present invention.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

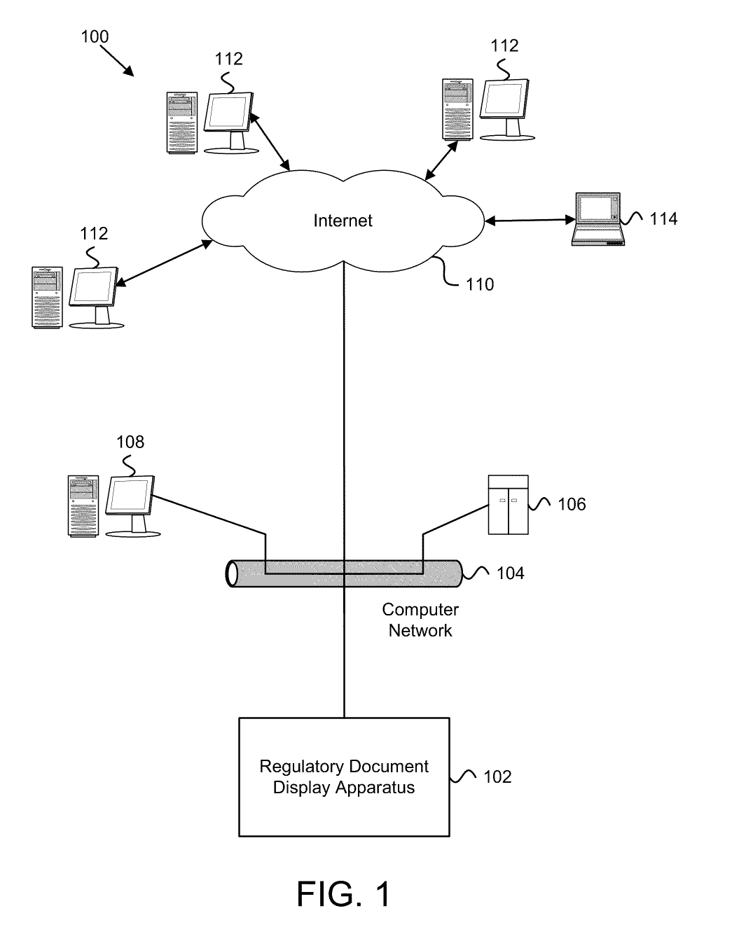

FIG. 1 depicts one embodiment of a system 100 for depicted regulatory document display. A regulatory document display apparatus 102 configured to display regulatory document and associated information in a first and second language is connected to a computer network 104. In one embodiment, a file server 106 and a computer 108 are also connected to the computer network 104. In another embodiment, the Internet 110 is connected to the computer network 104, to one or more computers 112, and to one or more laptop computers 114. One skilled in the art will recognize other system configurations with other computer types, connections, and peripheral equipment.

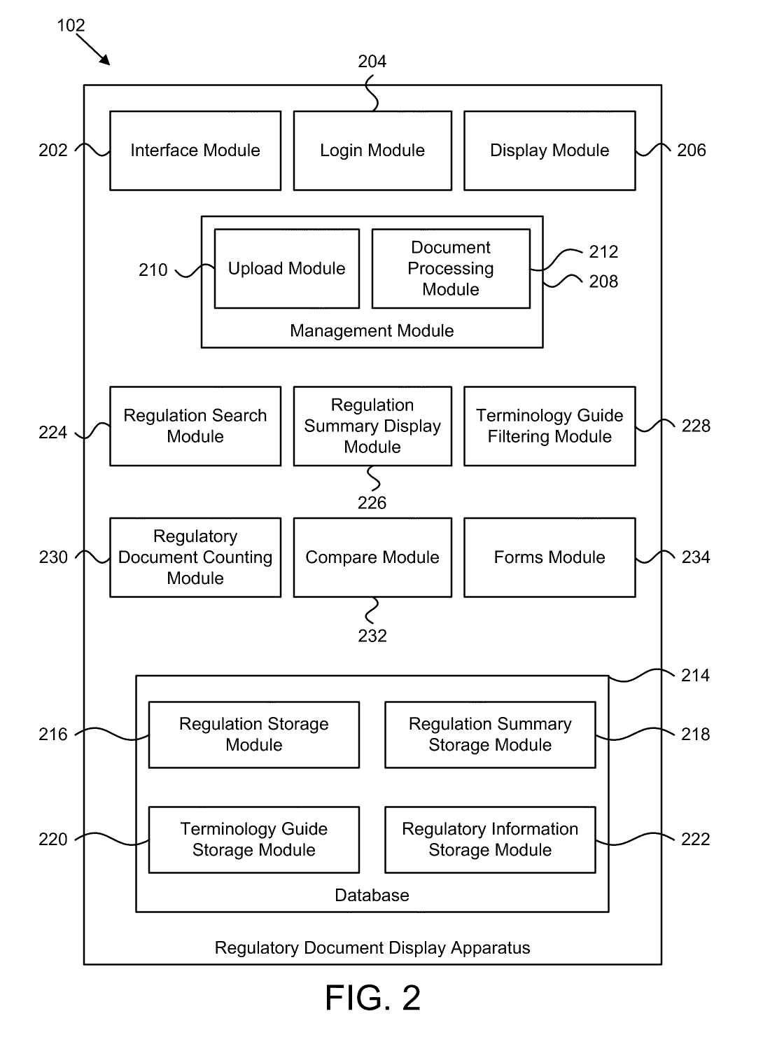

FIG. 2 is a more detailed depiction of the depicted regulatory document display apparatus 102 which includes an interface module 202 configured to accept user input from a keyboard, mouse or other user interface. The interface module 202 may also accept user input from the server 106, a computer 108 connected to the computer network 104 or a computer 112 or laptop 114 connected to the computer network 104 through the Internet 110. One skilled in the art will recognize other ways a user may provide input. The depicted regulatory document display apparatus 102 may also contain a login module 204 configured to login to the depicted regulatory document display apparatus 102 or to control access to authorized users. A display module 206 is also included and configured to display regulations, summaries of regulations, regulatory documents, and other user requested or regulatory information. A management module 208 is configured to manage updating the regulatory document display apparatus 102 through an upload module 210 and to manage regulations, regulation summaries, country summaries, tables and other regulatory documents through a document processing module 212.

A regulation as contemplated herein can be in many forms. For example, a regulation may be legislation, a regulation, a directive, an act, a notification, a rule, a guideline, a policy, a code, a decree, a decree law, a norma, a resolution, an order, a law, a disposition, an ordinance, a measure, a notice, a provision, a circular, an article, a dahir, an executive order, a declaration, a government decision, a letter, a standard, a communiqué, a legislative decree, a royal decree, a constitution, presidential decree, or a ministerial decree. The above identified regulation types are from various countries but are not all-inclusive. A regulation can be any official communication from any form of government. A regulation may be current, proposed, or archived. The term regulatory document as used herein includes regulations and also information regarding a regulation. The information may be any information in the regulatory document display apparatus 102. One skilled in the art will recognize other forms of regulations and regulatory documents.

The depicted regulatory document display apparatus 102 includes a database 214 configured to store regulations and associated information. The database 214 includes a regulation storage module 216, a regulation summary storage module 218, a terminology guide storage module 220, and a regulatory information storage module 222. The depicted regulatory document display apparatus 102 also includes a regulation search module 224, a regulation summary display module 226, a terminology guide filtering module 228, a regulation counting module 230, a compare module 232, and a forms module 234.

The regulation storage module 216 is configured to store information regarding regulations and/or regulations from various countries and jurisdictions. In one embodiment, the information regarding regulations and/or regulations are in a first language of each regulation's country of origin. Preferably, the first language of the country of origin is the official language of the country. The country of origin may have more than one official language. In an alternate embodiment, translations of the regulations are stored along with the regulations in the language of origin. The regulation search module 224 is configured to search in a second language information in the database regarding a regulation in the first language. The display module 206 then displays the information regarding the regulation found by the search. In an alternate embodiment, the information regarding the regulation is a regulation officially recorded in a first language of the regulation's country of origin. Alternatively, information about the regulation may be displayed such as a link to the text of the regulation, title of the regulation, or other pertinent information. Additionally, the regulations may be current, proposed, or archived. In one embodiment, the interface module 202 is used to allow a user to search for a desired regulation and the document processing module 212 is used to facilitate searching the regulation storage module in the second language. In an alternate embodiment, the regulation search module 224 translates search terms from a second language to a first language and then searches a regulation in the first language. In an alternate embodiment, the regulations in a first language are in a database accessible through the computer network 104 or Internet 110.

The compare module 232 is configured to compare a selected regulation or various parts of its contents to one or more corresponding regulations or recommended standards from a different jurisdiction or country or international source of such information. In one embodiment, the compare module 232 is configured to compare tabulated data extracted from a regulation to tabulated data extracted from one or more corresponding regulations from a different jurisdiction or country. In a further embodiment, the compare module 232 is configured to also include user inputted tabulated data to compare with the data extracted from one or more regulations.

In one embodiment, the forms module 234 is configured to allow a user to access governmental forms from various countries, fill out the forms, and print the forms. In another embodiment, the regulatory information storage module 222 is configured to contain permitting requirements for jurisdictions, compliance schedules, country regulation overviews, numerical emissions and/or standards tables, and other information that may help a user comply with regulations of a particular country or jurisdiction. The other modules of the depicted regulatory document display apparatus 102 will be further explained in the following figures.

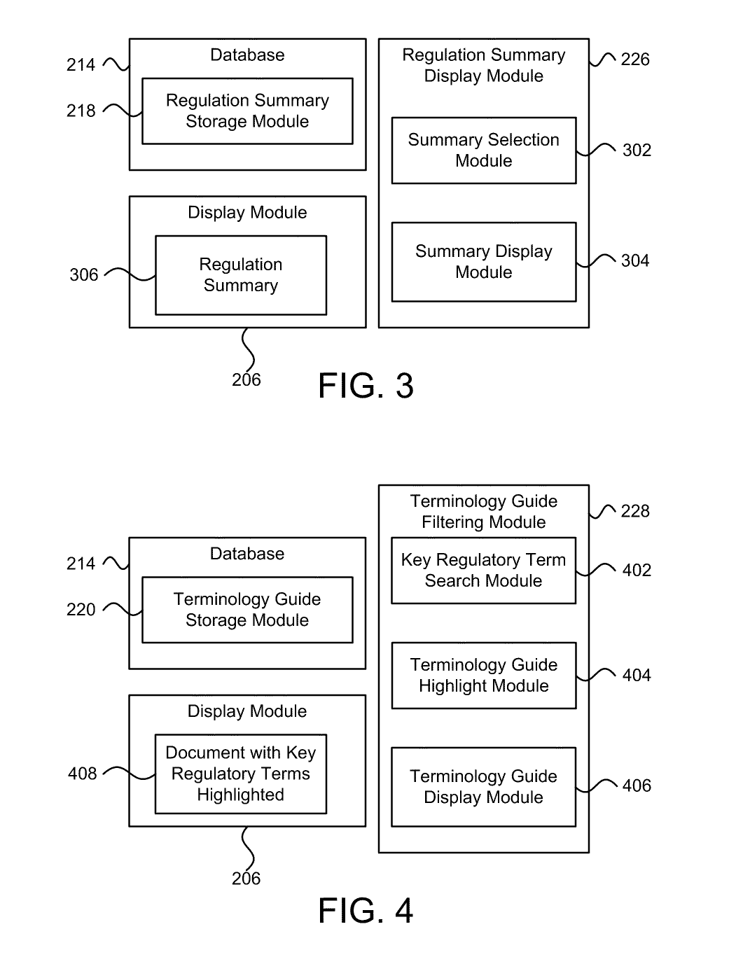

FIG. 3 is a more detailed depiction of the regulation summary display module 226 which is configured to display a summary of the regulation identified by the regulation search module 224. The regulation summary storage module 218 in the database 214 is configured to store a summary of a regulation in a first language of the regulation's country of origin and a translation of the summary in a second language. In an alternate embodiment, the summary of a regulation is in a database accessible through the computer network 104 or the Internet 110. A summary selection module 302 is part of the regulation summary display module 226 and is configured to allow a user to select, through the interface module 202, a summary, in the first language or second language, of the regulation identified by the regulation search module 224. The selected summary is stored in the regulation summary storage module 218. A summary display module 304 then displays the selected regulation summary 306 on the display module 206.

Preferably, for a particular regulation of a country, the summary in the first language is written and translated to a second language by an expert that has actual knowledge of the regulatory governmental structure in the country, the culture of the country, and knowledge of how to correctly translate the summary. Experts involved in writing and updating regulation information are part of a Global Resource Network. An expert in the Global Research Network, in one embodiment, can upload summaries, updates, or other information through the upload module 210 from the Internet 110. As the updated information is disseminated in the Global Resource Network, other members can assess the updated information's impact and can further update or harmonize the information.

In a further embodiment, the summary includes a list of requirements for obtaining a permit, getting regulatory agency approval, passing an inspection, or the like. In another embodiment, the summary includes an agency contact list of those in authority in a jurisdiction, agencies administering regulations, and the like. In another embodiment, the summary includes names of regulatory agencies with organizations charts. One skilled in the art would recognize other pertinent information that may be included in a summary of a regulation.

FIG. 4 is a more detailed depiction of the terminology guide filtering module 228 for highlighting key regulatory terms in a regulatory document. The terminology guide filtering module 228 includes a key regulatory term search module 402, a terminology guide highlight module 404, and a terminology guide display module 406. The terminology guide storage module 220 in the database 214 is configured to store key regulatory terms and associated information of a country or jurisdiction. Preferably, the key regulatory terms are also identified and linked to a linguistically and culturally accurate translation by a member of the Global Resource Network. In one embodiment, a key regulatory term is a term that has particular significance in a country so that providing a translated explanation of the significance of the term in the particular culture, country, or jurisdiction of origin will benefit a user searching regulation information in a second language to which the key regulatory term is translated. In an alternate embodiment, the key regulatory terms are in a database accessible through the computer network 104 or Internet 110.

The key regulatory term search module 402 is configured to search a regulatory document for a key regulatory term when the regulatory document is to be displayed on the display module 206. Preferably the regulatory document to be displayed is selected by a user through the interface module 202 and the regulatory document is processed and displayed through the document processing module 212. The regulatory document to be displayed may be any regulatory document in the database 214 or may also be a regulatory document downloaded to the depicted regulatory document display apparatus 102 from a device connected to the computer network 104 or through the Internet 110.

The terminology guide highlight module 404 highlights any key regulatory term from the terminology guide storage module 220 found in the regulatory document as it is displayed 408 on the display module 206. In an alternate embodiment, in addition to highlighting key regulatory terms in a displayed regulatory document, the terminology guide highlight module 404 displays a list of the key regulatory terms found in the displayed regulatory document.

The terminology guide display module 406 displays the associated information linked to a key regulatory term found in the regulatory document on the display module 206 as a mouse cursor passes over the highlighted key regulatory term. In an alternate embodiment, the associated information linked to a key regulatory term is displayed when the key regulatory term is selected. These highlighted regulatory terms are those that the inventors and the experts in the Global Resource Network have identified and will continue to identify as being subject to linguistic and cultural nuances the difference and understanding by users of which is vital for proper understanding of business and other appropriate decisions and actions. One skilled in the art will recognize other embodiments to display the associated information linked to a key regulatory term highlighted in a regulatory document on the display module 206.

An example of a key regulatory term is Small and Medium Enterprises (“SME”) which has a specifically defined meaning within the environmental standards and requirements in other countries and institutions (e.g., The European Union, The World Bank Group, United Nations Environment Programme, and others), but has no official, specific definition of Small and Medium Enterprises in China's regulations. There is only a general concept of SME in China. In this example, the database 214 may contain a definition of SME in English along with a translation in Chinese and a corresponding explanation that indicates that SME has a common concept in Chinese regulations, but does not have an official definition.

Another example is the term “Three Synchronicities,” a China-unique environmental permitting-type requirement but virtually with no equivalent meaning, intention nor governmental definition in any other country in the world. The terminology guide storage module 220 may contain this term and a definition in Chinese, as well as an explanation of the term in Chinese. To further illustrate the potential confusion in the English explanation of this term to a non-Chinese speaking and/or reading user is that the “Three Synchronicities” requirement may also be translated into the phrase “Three Simultaneousness” requirement. The terminology guide storage module 220 may contain the key regulatory term “Three Synchronicities” and associated information in the form of a definition, if any, in English, as well as an explanation of the Chinese term in English.

For example, the English explanation may state that “Three Synchronicities” means that the environmental abatement systems are designed, constructed, and operated at the same time as the design, construction, and operations of industrial facilities. The English explanation might further explain to the user that the “Three Synchronicities” policy is considered one of the most important environmental protection policies in China and is in fact referred to in a number of China regulations. It is therefore crucial that any system user, i.e., businesses desiring to open and operate a manufacturing facility in China, to thoroughly understand via the invention this often confusing term that in fact has no direct English equivalent translation.

By way of reference, the Chinese “Three Synchronicities” requirement example is by no means a unique or sole phraseology problem that is addressed and clarified by this invention. In fact, there are numerous such examples and similar problems in many country's regulations throughout the world. Thus, in this way, the terminology guide filtering module 228 may have translations in various languages and may also clarify which definitions pertain to which country or culture.

Key regulatory terms in a single language that are used in different cultures also may have culturally unique meanings. For example, a key regulatory term in English with a given definition in the United States of America may have a very different definition in England, Australia, Canada or other English speaking countries.

Preferably, the key regulatory term in a first language includes a definition of the key regulatory term in the first language and may define the country or culture associated with the key regulatory term. The translation of the key regulatory term in a second language identifies the country or culture to which the translation pertains and may contain a definition of the key regulatory term as is relevant in that country or culture. The terminology guide storage module 220 may also contain other pertinent information regarding the translation of the key regulatory term, such as business impacts, history of the term, associated regulations, effective dates of the regulations, and so forth. One skilled in the art would recognize other information to be included with a key regulatory term.

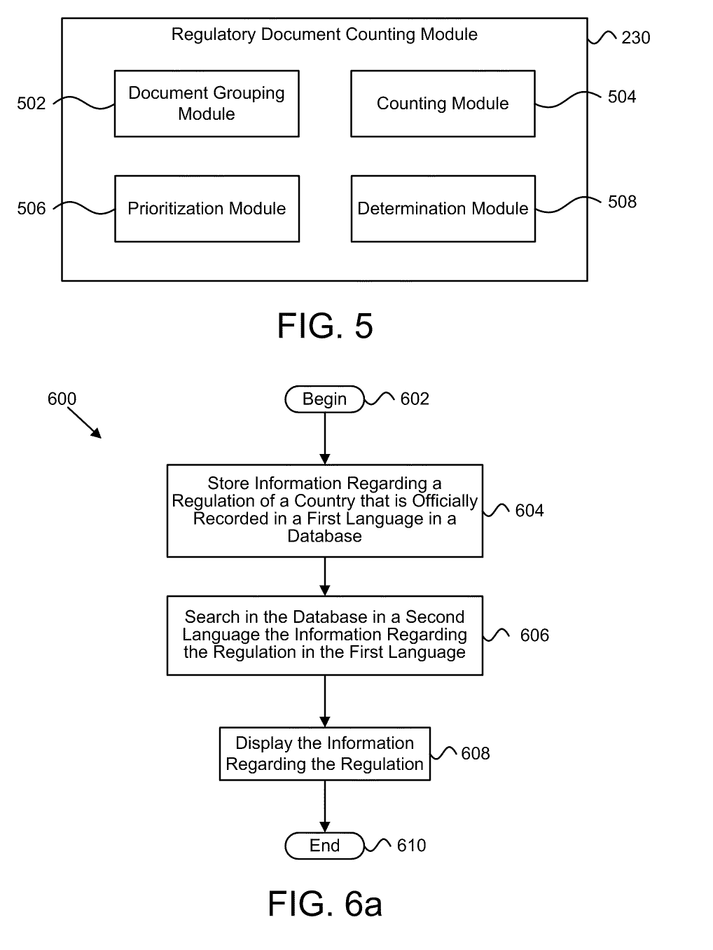

FIG. 5 depicts one embodiment of a more detailed illustration of the regulatory document counting module 230 for counting the number of times a regulatory document part of a group of regulatory documents is accessed by users. The resulting count is used to assign a ranking level to a regulatory document and the ranking is used to prioritize actions to be performed on the regulatory document. The regulation counting module includes a document grouping module 502, a counting module 504, a prioritization module 506, and a determination module 508.

The document grouping module 502 separates regulatory documents stored in the database 214 that are accessed by users into groups. In one embodiment, a group may be defined as all of the regulatory documents for a particular country. In another embodiment, a group may be defined as environmental regulatory documents. A grouping may be air quality regulations, emissions standards, safety standards or any other convenient grouping. The counting module 504 increases a count every time a regulatory document within a group is accessed by a user. In one embodiment, the count is periodically reset for a document or for every document within a group. In another embodiment, groups may be changed through the upload module 210, such as when a new document is added or an existing document is removed.

The prioritization module 506 uses the count from the counting module 504 to assign a priority level to each regulatory document within the specified group based on the results of the counting module 504. The determination module 508, in one embodiment, is configured to determine an action to be taken on each regulatory document based on the priority level assigned to each document by the prioritization module 506. For example, a first regulatory document that is assigned a high priority level based on a large access count may be queued for translation in its entirety from the official governmental language(s) prior to a second regulatory document having a lower priority level. Similarly, the priority level assigned to a document may impact the order in which it is queued for extraction of key regulatory terms from the regulatory document. In a further example, the priority level of a document may affect the time that it is reviewed to determine any regulatory requirements and business impacts to users of the regulatory document. One skilled in the art would recognize other actions to be taken on a regulatory document based on its priority level.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

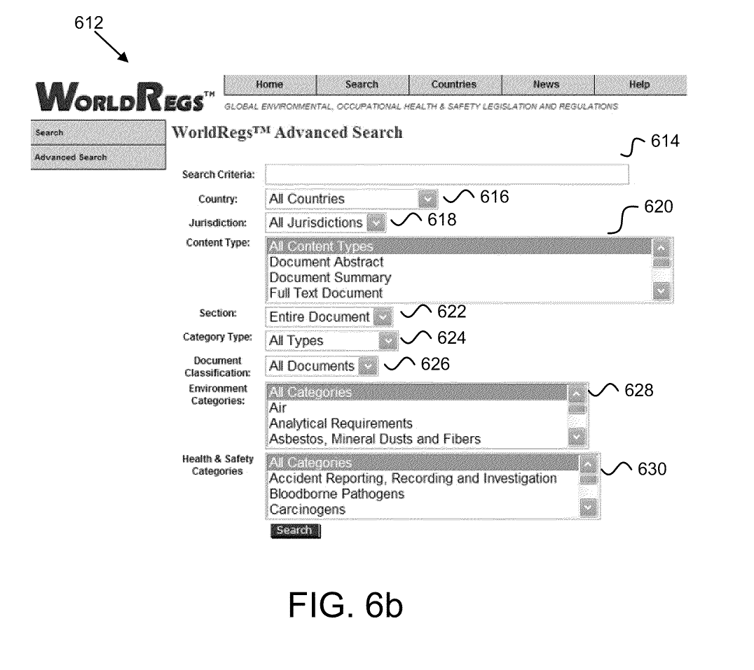

FIG. 6a is a schematic flow chart diagram illustrating one embodiment of a process 600 for displaying information regarding regulations in a first language based on a search in a second language. The process 600 may also display a regulation officially recorded in a first language of the regulation's country of origin or other regulatory documents and related information.

The depicted process 600 begins 602 with the upload module 210 storing 604 information regarding a regulation of a country that is officially recorded in a first language in the regulation storage module 216 in the database 214. The regulation search module 224 then searches 606 the regulation storage module 216 in a second language the information regarding the regulation in the first language. Alternatively, the information regarding the regulation is a regulation officially recorded in a first language of the regulation's country of origin. For example, a regulation may be stored in the regulation storage module 216 in Italian. A user could initiate a search through the interface module 202 in English and would search information associated with the regulation in Italian. The associated information could be key terms extracted from the Italian regulation and translated to English or a summary of the regulation translated to English. Various search parameters will be examined in FIG. 6b. Once the search 606 locates a regulation meeting the search criteria, the display module 206 displays 608 the regulation. In another embodiment, the display module 206 displays the title of the regulation, a summary of the regulation, or other associated information.

In an alternate embodiment, the regulation search module 224 searches 606 by translating search terms in a second language to a first language and then searches a regulation in the first language. For example, search terms are translated from English to Italian and then the Italian search terms are used to search directly a regulation in Italian.

FIG. 6b is a depiction 612 of various search parameters used by the regulation search module 224. A search criteria window 614 allows a user to enter search terms. In addition, a user can search by country 616, jurisdiction 618, document content type 620, document section 622, category type 624, document classification 626, environmental category 628, and health & safety category 630. One skilled in the art will recognize other search criteria appropriate for the type of regulation searched.

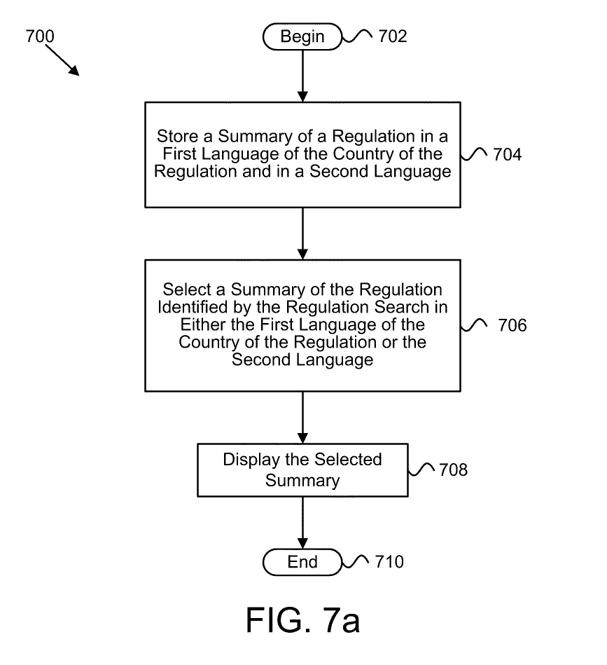

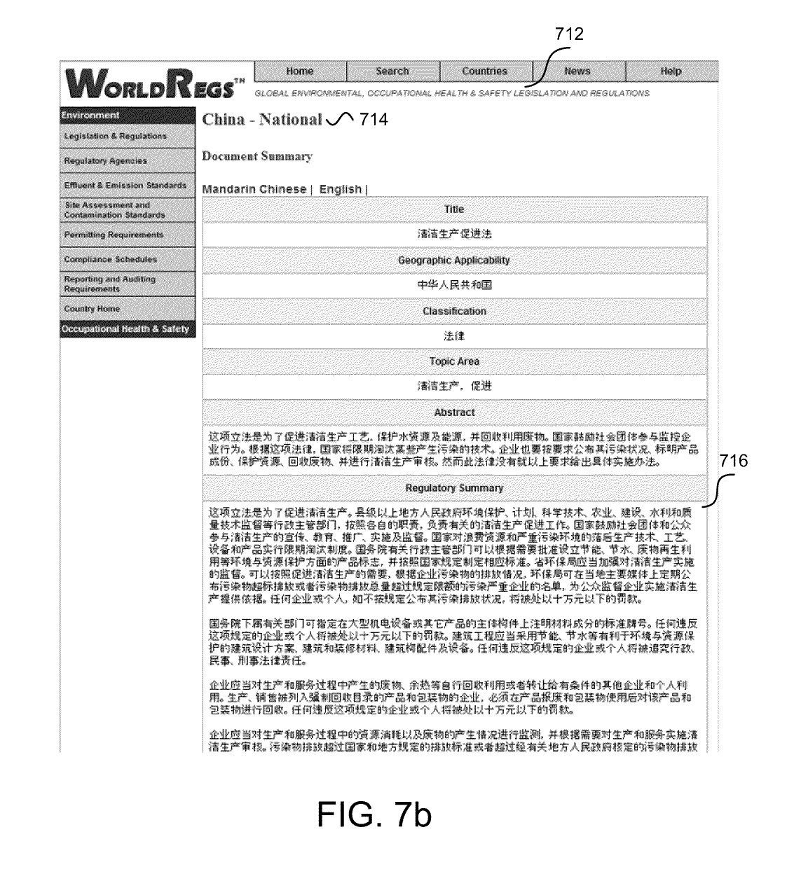

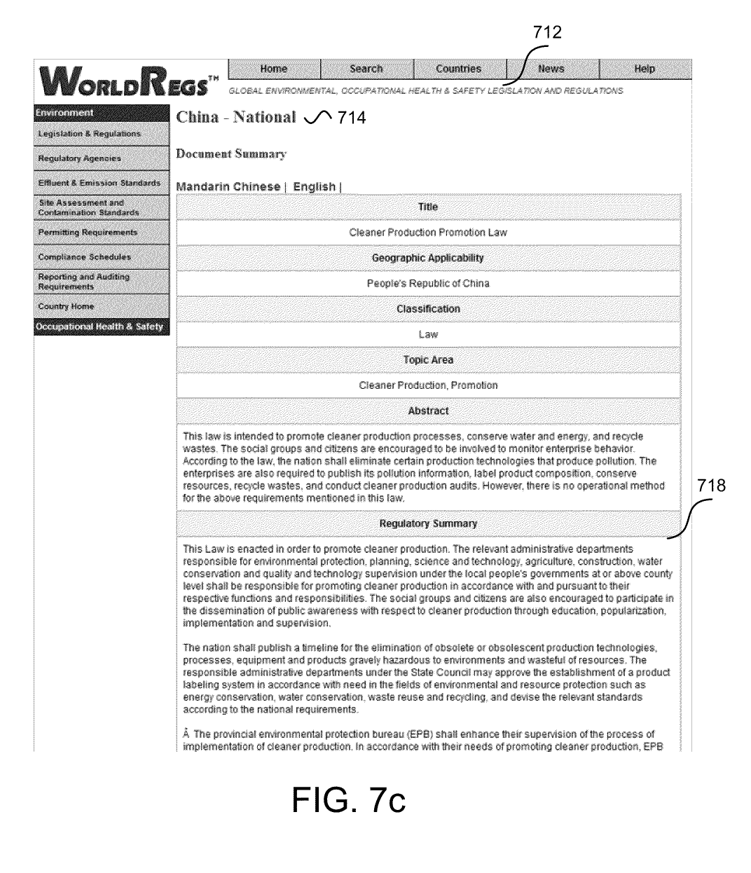

FIG. 7a is a schematic flow chart diagram illustrating one embodiment of a process 700 for displaying a summary of the regulation of a country identified by the search of process 600. The process 700 begins 702 with the upload module 210 storing 704 in the regulation summary storage module 218 a summary of a regulation in a first language of the country of origin of the regulation and in a second language. For example, a Chinese regulation may be in the Mandarin language. A summary of the regulation in Mandarin may be stored in the regulation summary storage module 218 along with an English translation of the summary. Preferably, the summary in the first and second language are written and maintained by a person in the Global Resource Network with knowledge of the regulation, regulatory agencies involved with the regulation, knowledge of how the regulation applies in the culture and country, and knowledge of how to correctly translate the regulation to the second language.

The summary selection module 302 then selects 706 a summary stored in the regulation summary storage module 218 of the regulation identified in the regulation search of the process 600 of FIG. 6a in either the first language of the country of the regulation's origin or second language. The summary display module 304 then displays 708 the selected summary on the display module 206 and the process ends 710.

FIG. 7b is a depiction of a display by the summary display module 304 of a regulation summary on the display module 206. The display includes the regulation title 712, the country and jurisdiction of the regulation 714, and the regulation summary 716 in the first language of the country of the regulation's origin. In this example, the country of origin of the regulation is China, the jurisdiction is “National,” and the summary is shown in Mandarin Chinese.

FIG. 7c is an alternate depiction of a display by the summary display module 304 of a regulation summary on the display module 206. The display again includes the regulation title 712, the country and jurisdiction of the regulation 714. In this example, a summary of the regulation 718 is shown in the second language of English.

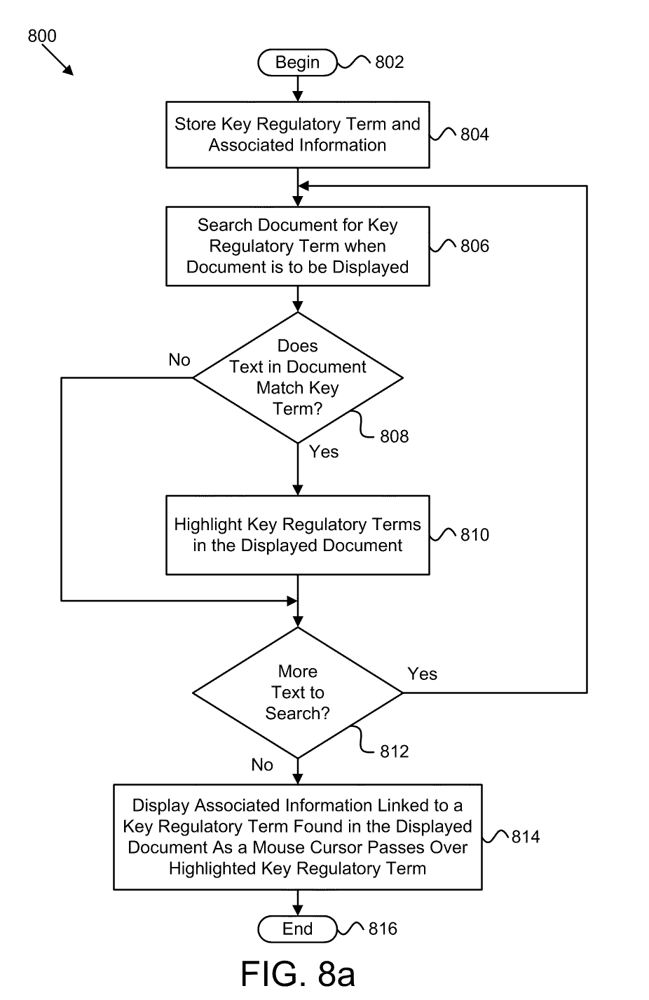

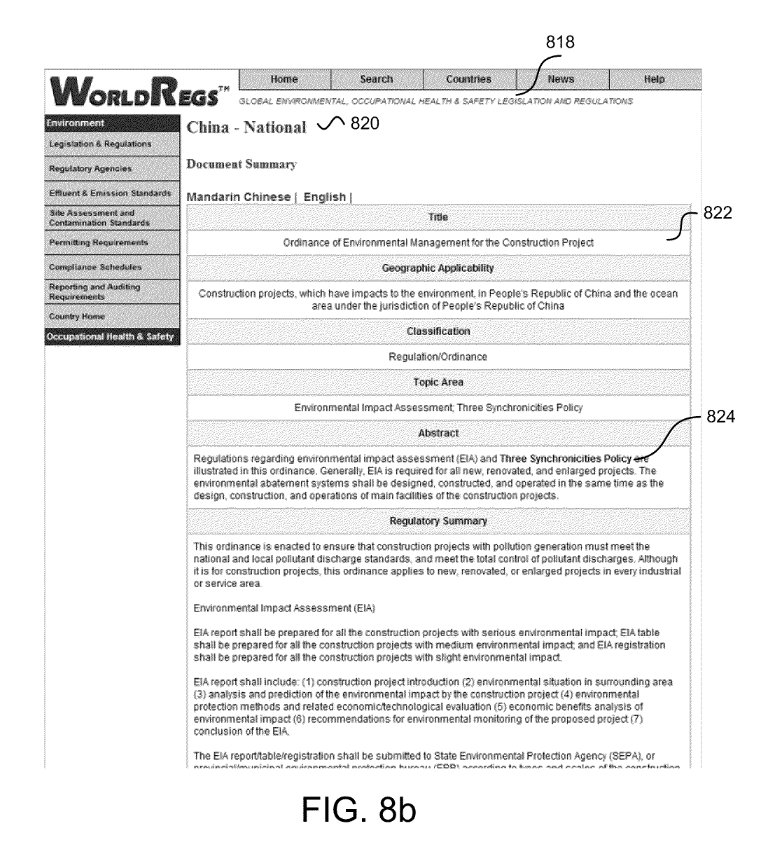

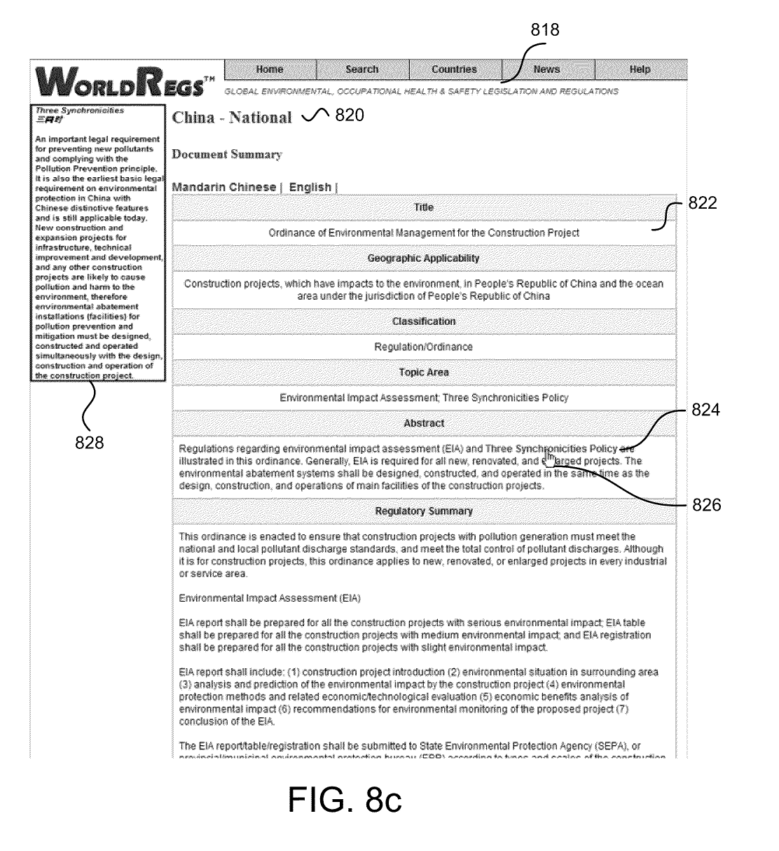

FIG. 8a is a schematic flowchart of a process 800 to highlight key regulatory terms in a document and associated information. The process 800 searches any document to be displayed and from any process that displays a document or other text on the display module 206. The process begins 802 with the upload module 210 storing 804 key regulatory terms and linked associated information in the terminology guide storage module 220.

When a document is to be displayed on the display module 206, the key regulatory term search module 402 searches 806 for key regulatory terms in the document. If a key regulatory term in found in the document 808, the terminology guide highlight module 404 highlights 810 the key regulatory term in the document. If there is more text to be searched 812, the process 800 returns and searches 806 for another key regulatory term. When there is no more text to be searched 812, the document is displayed on the display module 206 with all of the found key regulatory terms highlighted.

When a mouse cursor passes over a highlighted key regulatory term on the display module 206, the terminology guide display module 406 displays 814 the linked associated information on the display module 206, and the process ends 816. In an alternate embodiment, in addition to the key regulatory terms being highlighted in the document displayed on the display module 206, all of the key regulatory terms found and highlighted in the document are also displayed together on the display module.

In one embodiment, the document to be displayed on the display module is in the database 214. In another embodiment, document to be displayed is accessible from the Internet 110 or on a server attached to a computer network 104.

FIG. 8b is a depiction of an example of a document displayed on the display module 206 with a key regulatory term highlighted. The document is a regulation summary show with the title of the regulation 818, country and jurisdiction of the regulation 820, and highlighted key regulatory term 822. In this example, the regulation is from China and the key regulatory term, “Three Synchronicities,” is highlighted 824.

FIG. 8c is a further depiction of an example of a document displayed on the display module 206. In this example, the same regulation information is displayed. The display shows the title of the regulation 818, country and jurisdiction of the regulation 820, title of the regulation 818, and highlighted key regulatory term 824. In addition, a mouse cursor 826 is shown over the key regulatory term “Three Synchronicities.” A separate window 828 shows the key regulatory term's linked associated information. The associated information is preferably a definition of the key regulatory term written by a person in the Global Resource Network that identifies the meaning of the key regulatory term as it pertains to the country of origin of the term. Other embodiments may include a history of the key regulatory term, business impact, links to other documents, or the like. One skilled in the art will recognize other information related to a key regulatory term that may be displayed.

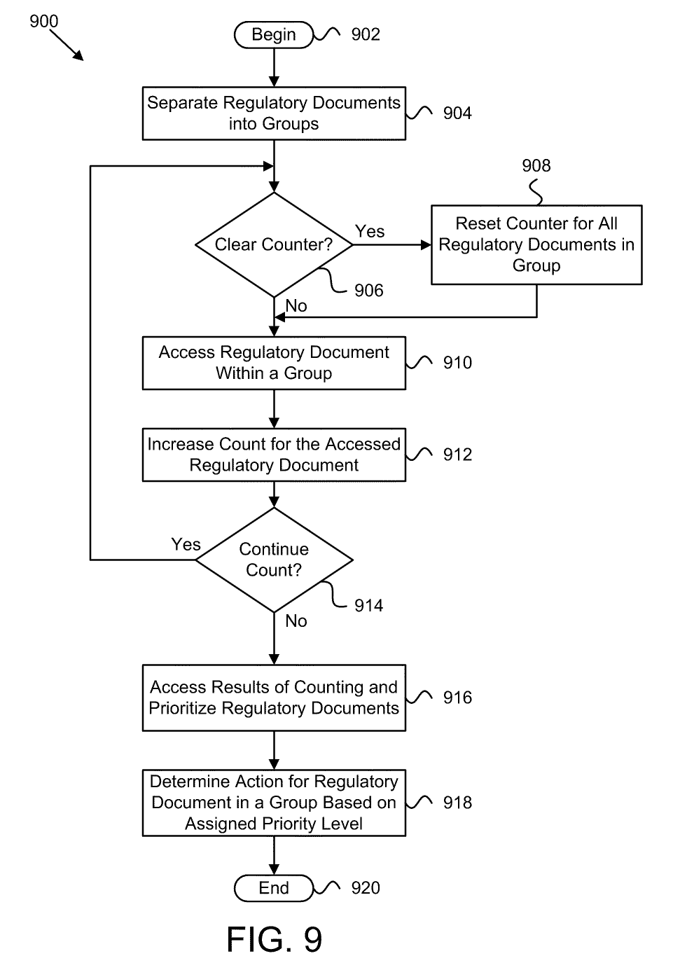

FIG. 9 is a schematic flow chart diagram illustrating one embodiment of a process 900 of using the regulatory document counting module 230 to count the number of times each of a group of regulatory document is accessed. The process 900 also assigns a priority level to the document for an action, such as translation, gleaning key regulatory terms, and other appropriate actions, to be taken on the document.

The depicted process 900 begins 902 with the document grouping module 502 separating 904 regulatory documents into groups. The counting module 504 then determines 906 if there is a command to clear the counter. If a clear counter command is given, the counter for one or all the documents within a group may be reset 908. If a reset counter command is not given 906, then the counting module 504 waits 910 for a regulatory document within a group to be accessed. When a regulatory document is accessed 910, the counting module 504 increases 912 the count for the regulatory document. The counting module 504 then determines 914 whether to continue counting. If the counting module 504 continues the counting process 914, the counting module 504 returns to step 906.

If the counting module 504 stops the counting process 914, the prioritization module 506 accesses 916 the stored count for each regulatory document in a group and assigns a priority level to each regulatory document in the group. In one embodiment, the counting stops due to user input. In an alternate embodiment, the counting stops automatically at a pre-determined time or based on some other parameter such as a count reaching a certain number. The priority level for a regulatory document may simply equate to the count for that document. In an alternate embodiment, the priority level of a regulatory document may have a weighting factor multiplied by the count. A weighting factor could be based on the size of a country's economy, number of licensed users in a particular country, availability of expertise to translate a document, or any other factor found to be useful. One skilled in the art would recognize other formulas for determining a priority level of a regulatory document.

The determination module 508 then determines 918 an action to be taken for a regulatory document based on the assigned priority level, and the process ends 920. In one embodiment, an action may be to translate the regulatory document into another language. In another embodiment, the action may be to glean key regulatory terms from the regulatory document. In another embodiment, the action may be to display the regulatory documents within a group by number of times accessed. In yet another embodiment, the action may be to determine the potential business impact of the regulations spelled out in the regulatory document. One skilled in the art will recognize other actions to be taken based on priority levels assigned to regulatory documents.

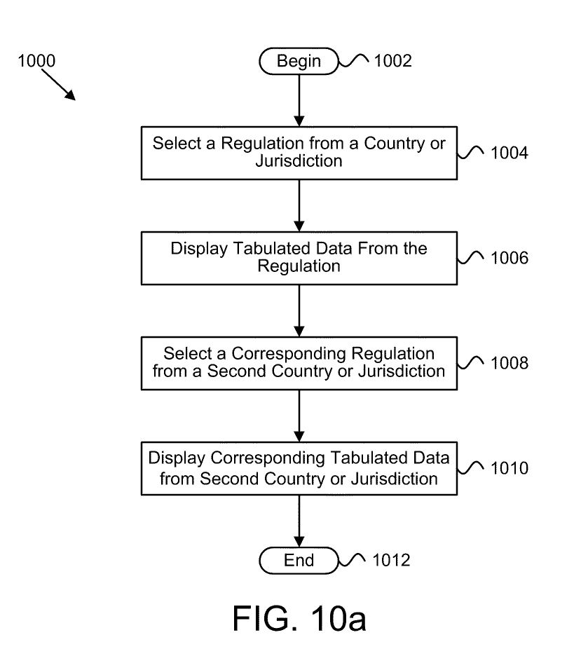

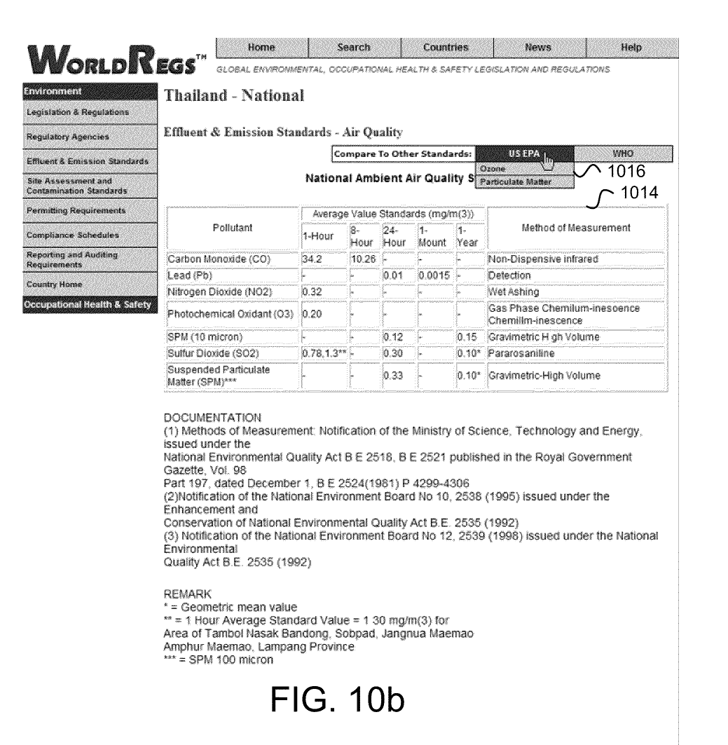

FIG. 10a is a schematic flow chart diagram of a process 1000 to compare a regulation to one or more corresponding regulations from a different jurisdiction or country. The process 1000 begins 1002 with the compare module 232 selecting 1004 a regulation from a country or jurisdiction. The compare module 232 then displays 1006 tabulated data from the selected regulation. The compare module 232 then selects 1008 regulation from another country or jurisdiction. The compare module 232 then displays 1010 tabulated data from the second regulation and the process ends 1012.

In an alternate embodiment, the compare module 232 allows tabulated data from more than two regulations. In another embodiment, the compare module 232 allows a user to enter data in a tabulated form through the interface module 202 and compare the user data to tabulated data from regulations. One skilled in the art will recognize other regulatory data to compare to regulations or other configurations of how regulatory data from regulations is displayed. One embodiment is shown in FIG. 10b. Another embodiment may show columns of tabulated regulatory data side by side.

FIG. 10b is a depiction of an example of a display comparing regulatory data from regulations. Regulatory data 1014 from a regulation is shown in tabulated form. In this example, tabulated data from an air quality regulation from Thailand is shown. Also shown is selection 1016 of another regulation. In this example, the user is in the process of selecting and comparing United States Environmental Protection Agency (US EPA) regulations to be displayed along with the regulation from Thailand. This comparison feature is important to multinational corporations seeking to understand and compare a foreign country's regulatory requirements to those of the host corporation's country regulatory agencies, its own internal global corporate policies, other global institutional standards and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for displaying information regarding a regulation in a first language from a search in a second language, the apparatus comprising:
a regulation storage module configured to store information regarding a regulation of a country that is officially recorded in a first language in a database;
a regulation search module configured to search in a second language the information regarding the regulation in the first language; and
a display module configured to display the information regarding the regulation identified by the regulation search module.

2. The apparatus of claim 1, wherein the information regarding the regulation is a regulation officially recorded in a first language of the regulation's country of origin.

3. The apparatus of claim 1, wherein the regulation search module is further configured to translate search terms in a second language to a first language and search a regulation in the first language.

4. The apparatus of claim 1, further comprising a regulation summary display module configured to display a summary of the regulation identified by the regulation search module, the regulation summary display module comprising:
a regulation summary storage module configured to store a summary of a regulation in a first language of the country of the regulation's origin and in a second language;
a summary selection module configured to allow a user to select a summary of the regulation identified by the regulation search module from the regulation summary storage module in the first language of the country of the regulation's origin or the second language; and
a summary display module configured to display the selected summary on the display module.

5. The apparatus of claim 4, wherein the regulation summary is written and translated by a person with actual knowledge of the regulation being summarized, its application in the country and culture of the regulation's origin, and knowledge of how to translate the regulation from the first language of the country of origin to the second language.

6. The apparatus of claim 4, wherein the regulation summary further comprises information selected from the group consisting of a business impact, a compliance requirement list, an agency contact list, a regulatory agency name, and an agency organizational charts.

7. The apparatus of claim 1, further comprising a terminology guide filtering module for highlighting key regulatory terms in a regulatory document, the terminology guide filtering module comprising:
a terminology guide storage module configured to store a key regulatory term and linked associated information;
a key regulatory term search module configured to search a regulatory document for a key regulatory term when the regulatory document is to be displayed on the display module;
a terminology guide highlight module configured to highlight the key regulatory term found in the regulatory document displayed on the display module; and
a terminology guide display module configured to display the associated information linked to a key regulatory term found in the regulatory document on the display module as a mouse cursor passes over the highlighted key regulatory term.

8. The apparatus of claim 1, further comprising a regulatory document counting module for counting the number of times each of a group of regulatory documents is accessed, the regulatory document counting module comprising:
a document grouping module configured to separate regulatory documents into groups;
a counting module configured to count the number of times a regulatory document within a group is accessed;
a prioritization module configured to assign a priority level to each regulatory document within a group based on the count from the counting module; and
a determination module configured to determine an action to be taken on a regulatory document based on the priority level assigned by the prioritization module.

9. The apparatus of claim 8 wherein the action to be taken on a regulatory document by the determination module is to one or more of translate the regulatory document, extract key regulatory terms, and assess business impacts.

10. The apparatus of claim 1, further comprising a compare module configured to compare a regulation to one or more corresponding regulations from a different jurisdiction or country.

11. The apparatus of claim 10, wherein the compare module is further configured to compare tabulated data extracted from a regulation to tabulated data extracted from one or more corresponding regulations from a different jurisdiction or country.

12. The apparatus of claim 10, further comprising comparing the regulations to corresponding user data.

13. The apparatus of claim 1, further comprising a forms module configured to allow users to select, use, and print official government forms.

14. The apparatus of claim 1, further comprising a regulatory information storage module configured to contain information from a country selected from the group consisting of a permitting requirement, a compliance schedule, a country regulation overview and an emissions table.

15. A system for displaying information regarding a regulation in a first language from a search in a second language, the system comprising:
a computer network;
a computer connected to the computer network;
a server connected to the computer network;
a regulatory document display apparatus connected to the computer network, further comprising:
a regulation storage module configured to store information regarding a regulation of a country that is officially recorded in a first language in a database;
a regulation search module configured to search in a second language the information regarding the regulation in the first language; and
a display module configured to display the information regarding the regulation identified by the regulation search module.

16. The system of claim 15, wherein the information regarding the regulation is a regulation officially recorded in a first language of the regulation's country of origin.

17. The system of claim 15, further comprising an Internet connection wherein a user can access the database through the Internet.

18. The system of claim 15, further comprising a regulation summary display module configured to display a summary of the regulation identified by the regulation search module, the regulation summary display module comprising:
a regulation summary storage module configured to store a summary of a regulation in a first language of the country of the regulation's origin and in a second language;
a summary selection module configured to allow a user to select a summary of the regulation identified by the regulation search module from the regulation summary storage module in the first language of the country of the regulation's origin or the second language; and
a summary display module configured to display the selected summary on the display module.

19. The system of claim 15, further comprising a terminology guide filtering module for highlighting key regulatory terms in a regulatory document, the terminology guide filtering module comprising:
a terminology guide storage module configured to store a key regulatory term and linked associated information;
a key regulatory term search module configured to search a regulatory document for a key regulatory term when the regulatory document is to be displayed on the display module;
a terminology guide highlight module configured to highlight the key regulatory term found in the regulatory document displayed on the display module; and
a terminology guide display module configured to display the associated information linked to a key regulatory term found in the regulatory document on the display module as a mouse cursor passes over the highlighted key regulatory term.

20. The system of claim 15, further comprising a regulatory document counting module for counting the number of times each of a group of regulatory documents is accessed, the regulatory document counting module comprising:
a document grouping module configured to separate regulatory documents into groups;
a counting module configured to count the number of times a regulatory document within a group is accessed;
a prioritization module configured to assign a priority level to each regulatory document within a group based on the count from the counting module; and
a determination module configured to determine an action to be taken on a regulatory document based on the priority level assigned by the prioritization module.

21. The system of claim 15, further comprising a compare module configured to compare a regulation to one or more corresponding regulations from a different jurisdiction or country.

22. The system of claim 15, further comprising a forms module configured to allow users to select, use, and print official government forms.

23. A signal bearing medium tangibly embodying a program of machine-readable instructions executable by a digital processing apparatus to perform operations to display information regarding regulations in a first language from a search in a second language, the operations comprising:
storing information regarding a regulation of a country that is officially recorded in a first language in a database;
searching in a second language the information regarding the regulation in the first language; and
displaying the information regarding the regulation identified by the regulation search.

24. The signal bearing medium of claim 23, wherein the information regarding the regulation is a regulation officially recorded in a first language of the regulation's country of origin.

25. The signal bearing medium of claim 23, wherein searching in a second language comprises translating search terms in a second language to a first language and searching a regulation in the first language.

26. The signal bearing medium of claim 23, wherein the instructions further comprise operations to display a summary of the regulation of a country identified by the regulation search, the operations comprising:
storing a summary of a regulation in a first language of the country of the regulation's origin and in a second language;
selecting a summary of the regulation identified by the regulation search in the first language of the country of the regulation's origin or the second language; and
displaying the selected summary.

27. The signal bearing medium of claim 23, wherein the instructions further comprise operations to highlight key regulatory terms in a regulatory document, the operations comprising:
storing a key regulatory term and linked associated information;
searching a regulatory document for a key regulatory term when the regulatory document is to be displayed;
highlighting the key regulatory term found in the displayed regulatory document; and
displaying the associated information linked to a key regulatory term found in the displayed regulatory document as a mouse cursor passes over the highlighted key regulatory term.

28. The signal bearing medium of claim 23, wherein the instructions further comprise operations to count the number of times each of a group of regulatory document is accessed, the module comprising:
separating regulatory documents into groups;
counting the number of times a regulatory document within a group is accessed;
assigning a priority level to each regulatory document within a group based on the number of times a regulatory document within a group is counted; and
determining an action to be taken on a regulatory document based on the assigned priority level of the regulatory document.

29. The signal bearing medium of claim 23, wherein the instructions further comprise operations to compare a regulation to one or more corresponding regulations from a different jurisdiction or country.

30. The signal bearing medium of claim 23, wherein the instructions further comprise operations to allow users to select, use, and print official government forms.

31. A method to display information regarding regulations in a first language from a search in a second language, the method comprising:
storing information regarding a regulation of a country that is officially recorded in a first language in a database;
searching in a second language the information regarding the regulation in the first language; and
displaying the information regarding the regulation identified by the regulation search.

32. The method of claim 31, wherein the information regarding the regulation is a regulation officially recorded in a first language of the regulation's country of origin.

33. The method of claim 31, wherein the method further comprises displaying a summary of the regulation of a country identified by the regulation search, the method comprising:
storing a summary of a regulation in a first language of the country of the regulation's origin and in a second language;
selecting a summary of the regulation identified by the regulation search in the first language of the country of the regulation's origin or the second language; and
displaying the selected summary.

34. The method of claim 31, wherein the method further comprises highlighting key regulatory terms in a regulatory document, the operations comprising:
storing a key regulatory term and linked associated information;
searching a regulatory document for a key regulatory term when the regulatory document is to be displayed;
highlighting the key regulatory term found in the displayed regulatory document; and
displaying the associated information linked to a key regulatory term found in the displayed regulatory document as a mouse cursor passes over the highlighted key regulatory term.

35. The method of claim 31, wherein the method further comprises counting the number of times each of a group of regulatory documents is accessed, the module comprising:
separating regulatory documents into groups;
counting the number of times a regulatory document within a group is accessed;
assigning a priority level to each regulatory document within a group based on the number of times a regulatory document within a group is counted; and
determining an action to be taken on a regulatory document based on the assigned priority level of the regulatory document.
